(19) United States
(12) Patent Application Publication
(10) Pub. No.: US 2015/0234102 A1
(43) Pub. Date: Aug. 20, 2015

(54) DYNAMICALLY FOCUSABLE MULTISPECTRAL LIGHT FIELD IMAGING

(71) Applicant: Drexel University, Philadelphia, PA (US)

(72) Inventors: Timothy Kurzweg, Philadelphia, PA (US); Weston Lee Aenchbacher, Talking Rock, GA (US); Adam K. Fontecchio, Downingtown, PA (US); Ben Eyal Pelleg, Haverford, PA (US)

(21) Appl. No.: 14/420,803

(22) PCT Filed: Aug. 20, 2013
(86) PCT No.: PCT/US2013/055641

§ 371 Date: Feb. 10, 2015

Related U.S. Application Data
(60) Provisional application No. 61/691,026, filed on Aug. 20, 2012.

(51) Int. Cl. G02B 5/20; G02B 13/00

(52) U.S. Cl. CPC G02B 5/203; G02B 13/0015

(57) ABSTRACT

A flexible, multispectral, light field imaging system comprising holographically-formed polymer dispersed liquid crystal (H-PDLC) stacks in a plenoptic camera architecture may capture multispectral light field data from a scene. Through manipulation of this multispectral light field data, digitally refocused spectral images may be created at different, selectable focal depths, with a single exposure.

### CROSS-REFERENCE TO RELATED APPLICATIONS

The instant application claims priority to U.S. provisional patent application No. 61/691,026, filed Aug. 20, 2012. U.S. provisional patent application No. 61/691,026 is incorporated by reference herein in its entirety.

### TECHNICAL FIELD

The technical field generally is related to dynamically focusable multispectral light field imaging and more specifically is related to a multispectral light field imaging system utilizing holographically formed polymer dispersed liquid crystal medium in a plenoptic camera architecture.

### BACKGROUND

In a typical plenoptic camera, the detector array from a traditional camera is moved back and replaced with an array of lenses. And the image sensor is, instead, placed at the back focal plane of the array of lenses. As a result, light that would have been focused to a single image sensor element becomes split into angular components, each angular component falling onto a different sensor element. The general treatment of spectral content by plenoptic cameras has been RBG capture by demosaicing, by, for example, incorporating a filter array at the lens plane that contains color filters, polarizers, and neutral density filters. While this approach may be capable of reconstructing a multispectral image formed at the plane of the array of lenses, all but one waveband along each trajectory is lost. And this loss may preclude image reconstruction at other synthetic image planes.

### SUMMARY

A flexible, hybrid, multispectral, light field imaging system comprising holographically-formed polymer dispersed liquid crystal (H-PDLC) stacks in a plenoptic camera architecture may capture multispectral light field data from a scene. Through manipulation of this multispectral light field data, digitally refocused spectral images may be created at different, selectable focal depths, with a single exposure. A single filter may block a narrow, specific spectral “stopband” with its reflective Bragg grating structure and may become transparent when a voltage is applied. By stacking different filters close to the imaging lens of a plenoptic camera, or the like, spectral light field data may be captured by making one filter transparent per exposure and taking as many exposures as there are filters. The use of H-PDLC filters provides flexibility in selecting specific bands to be sampled, order of bands to be sampled, and alternate filter geometries. For example, a hybrid multispectral/light field camera may include filter masks, wherein a filter mask may comprise single filter elements with different stopbands patterned across the plane of the filter.

### BRIEF DESCRIPTION OF THE DRAWINGS

In the drawings, like reference numerals designate corresponding parts throughout the several views.

FIG. 1 is an example illustration of dynamically focusable light field imaging.

FIG. 2 depicts an example system for dynamically focusable light field imaging.

FIG. 3 is a ray diagram of an example plenoptic camera.

FIG. 4 is another example ray diagram illustrating that the lenslet array is placed at the usual detector array location.

FIG. 5 is another example ray diagram illustrating that the number of detector elements behind each lenslet determines the angular resolution of ray trajectories;

FIG. 6 is another example ray diagram illustrating an image from a (1, v) perspective.

FIG. 7 is another example ray diagram illustrating an image from a (2, v) perspective.

FIG. 8 is another example ray diagram illustrating an image from a (3, v) perspective.

FIG. 9 is another example ray diagram illustrating an image from a (4, v) perspective.

FIG. 10 is another example ray diagram illustrating the a complete set of L(u,v,s,t) constitutes the light field.

FIG. 11 is an example illustration of two states of an H-PDLC medium that may be achieved via electrical biasing.

FIG. 12 depicts graphs of example transmission spectra of an H-PDLC filter with and without applied voltage.

FIG. 13 depicts graphs of example transmission spectra of a five layer multicolor H-PDLC filter stack with varying applied voltage.

FIG. 14 depicts ray diagrams of the herein described dynamically focusable light field imaging system with a stack including single-stopband filters and a filter mask.

FIG. 15 is another example ray diagram illustrating introduction of a filter array proximate the imaging lens.

FIG. 16 is another example ray diagram illustrating the dynamic filters turned off.

FIG. 17 is another example ray diagram illustrating an array of static filters.

FIG. 18 is another example ray diagram illustrating a two-exposure technique wherein all filters are on and are subsequently turned off.

FIG. 19 is another example ray diagram illustrating a two-exposure technique wherein all filters are off and are subsequently turned on.

FIG. 20 is another example ray diagram illustrating stacked filters wherein different filters of the stacks are activated.

FIG. 21 is another example ray diagram illustrating stacked filters wherein different filters of the stacks are activated.

FIG. 22 is another example ray diagram illustrating stacked filters wherein different filters of the stacks are activated.

FIG. 23 is another example ray diagram illustrating stacked filters wherein different filters of the stacks are activated.

FIG. 24 is another example ray diagram illustrating target chemical detection.

FIG. 25 is another example ray diagram illustrating target chemical detection wherein specific filters are chosen based upon the specific task.

FIG. 26 illustrates example graphs of transmission spectra for an H-PDLC medium comprising triallyl isocyanurate and an H-PDLC medium not comprising triallyl isocyanurate.

FIG. 27 illustrates digitally-refocused images created from the light field data captured in a single exposure from the trial system.

FIG. 28 illustrates an example configuration for forming four spatially multiplexed H-PDLC filters on a single substrate.

FIG. 29 is a flow chart of an example process for dynamically focusable light field imaging as described herein.

### DETAILED DESCRIPTION

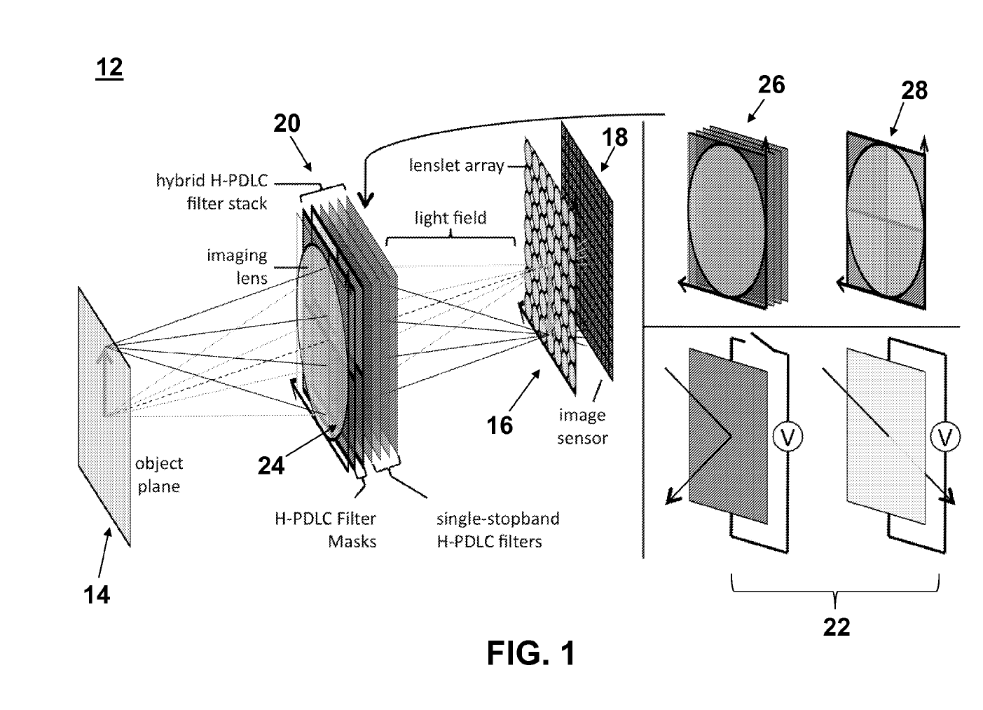

FIG. 1 is an example illustration of dynamically focusable light field imaging. The configuration 12 depicted in FIG. 1 comprises a flexible, hybrid, multispectral light field imaging system comprising holographically formed polymer dispersed liquid crystal (H-PDLC) stacks in a plenoptic camera architecture. As described herein, the configuration 12 provides the ability to create digitally refocused images, at different focal depths, with a single exposure. The switching capabilities of H-PDLC spectral filters allows for capture of spectral light field data without precluding light field capture.

As shown in FIG. 1, an object, represented by object plane 14, may be imaged onto an array of lenses 16. As described herein, the array of lenses may also be referred to as a lenslet array and each lens of the array may be referred to as a lenslet. The lenslets of array 16 may divert each incoming ray of light onto its own image sensor location of image sensor 18. Accordingly, light field data, rather than a two-dimensional (2-D) image is gathered at the image sensor 18. The spectral content of the light field may be investigated via utilization of the switching capabilities of the holographically formed polymer dispersed liquid crystal (H-PDLC) filter stack 20.

The novel plenoptic camera platform (depicted in FIG. 1) comprising H-PDLC filters and filter stacks provides the ability to capture a fully-parameterized spectral light field. H-PDLC filters may be switched between states very quickly and provide a wide range of design flexibility. A single H-PDLC filter may block a narrow, specific spectral “stopband” with its reflective Bragg grating structure and become transparent when a voltage is applied, as depicted in illustrative insert 22 of FIG. 1. By stacking different filters proximate to an imaging lens 24 of a plenoptic camera configuration 12, spectral light field data may be captured by making one H-PDLC filter transparent per exposure and taking as many exposures as H-PDLC filters. The use of H-PDLC filters offers flexibility in specific bands sampled, order of bands sampled, and alternate filter geometries. Various H-PDLC filter masks may be configured wherein each mask may comprise a single filter element, as depicted in the stack 26 of single stopband filters, each mask may comprise multiple filter elements with different stopband patterns formed across the plane of a filter, as depicted in stack 28 of filters comprising multiple stopbands patterned spatially across the plane of each filter, or any appropriate combination thereof.

The herein described dynamically focusable light field imaging system provides the ability to capture of a fully-parameterized spectral light field. Along with the ability to create a two-dimensional photographic image that may be digitally refocused after the picture has already been taken, the herein described dynamically focusable light field imaging system provides digital refocusing of a three-dimensional “hypercube” generated through multispectral image capture. This structure has the standard two spatial dimensions, and the spectrum at each spatial coordinate constitutes the third dimension. Accordingly, spectral information may be obtained about a scene at different depths without having to adjust focus. The light field contains angularly resolved spectra for each point on the imaged object.

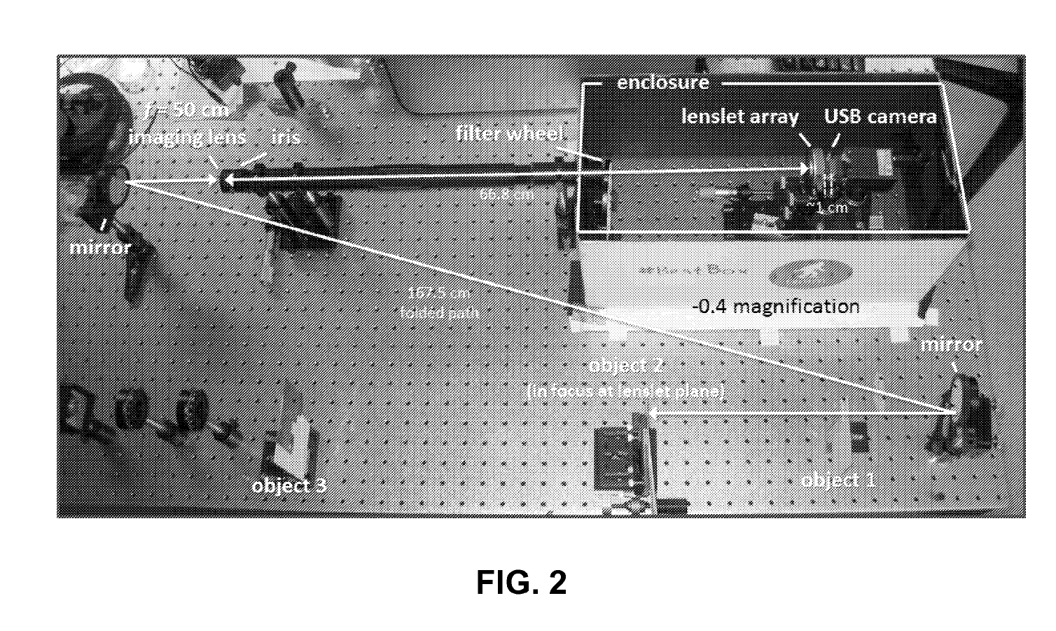

FIG. 2 depicts an example system for dynamically focusable light field imaging. The configuration and/or system depicted in FIG. 1 and FIG. 2 may support multiple wavelength regions by including spectral filters of any appropriate range of wavelengths (e.g., visible light, infrared light, etc.). Multiple object planes may be dynamically sampled resulting in a variable focal depth. Object planes may be viewed in focus simultaneously as if viewed with different lenses without modifying system hardware.

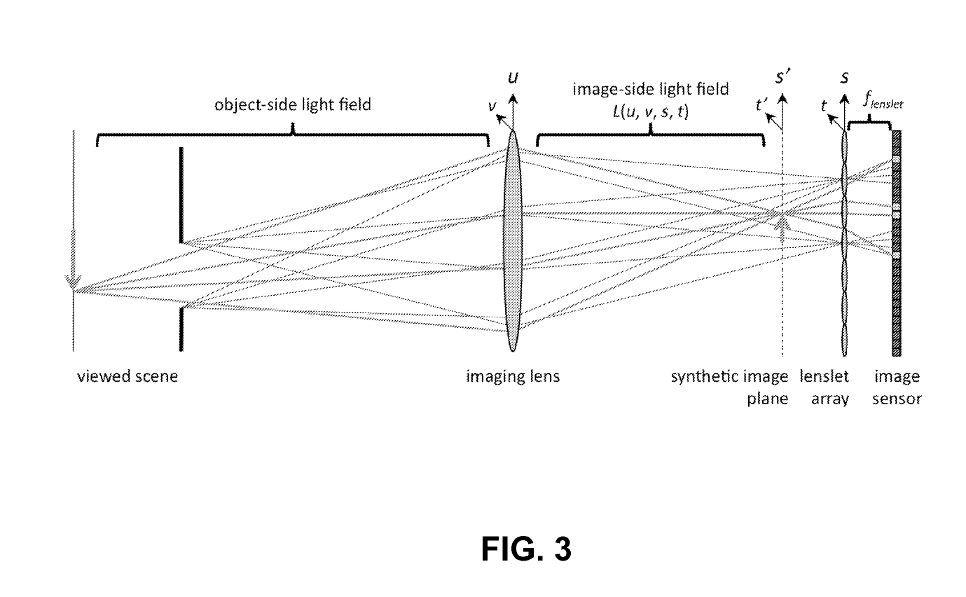

FIG. 3 is a ray diagram of an example plenoptic camera. The camera is set-up such that each detector in the image sensor records the light along a single trajectory, from the plane of the image lens (u-v) to the plane of the lenslet array (s-t). The collection of all of these measurements constitutes the light field, L(u, v, s, t), which may be manipulated to create “digitally refocused” images at a range of synthetic image planes (s′-t′). Each detector of the image sensor may have a conjugate square at the plane of the imaging lens, from which the ray bundle that falls onto the detector originates. And the light originating from that area may fall only on the described detector element. A projection of the detector array onto the plane of the imaging lens provides a gridded discretization of the imaging plane. Each location at this plane is given a (u, v) coordinate and each lenslet is given a (s, t) coordinate. Under this parameterization, each detector element measures the intensity along a single trajectory (u, v)→(s, t) and the assemblage of the intensities along all discrete trajectories is the light field L(u, v, s, t)]. The captured light field data may be digitally refocused at a range of “synthetic image plane” depths within the camera (s′-t′ plane in FIG. 3).

Incorporating, at the lens plane, a color filter array (not shown in FIG. 3) may convert all trajectories corresponding to each (u, v) bin to a spectral channel. And as described herein, to achieve hyperspectral and multispectral imaging, the color filter array may comprise H-PDLC filters.

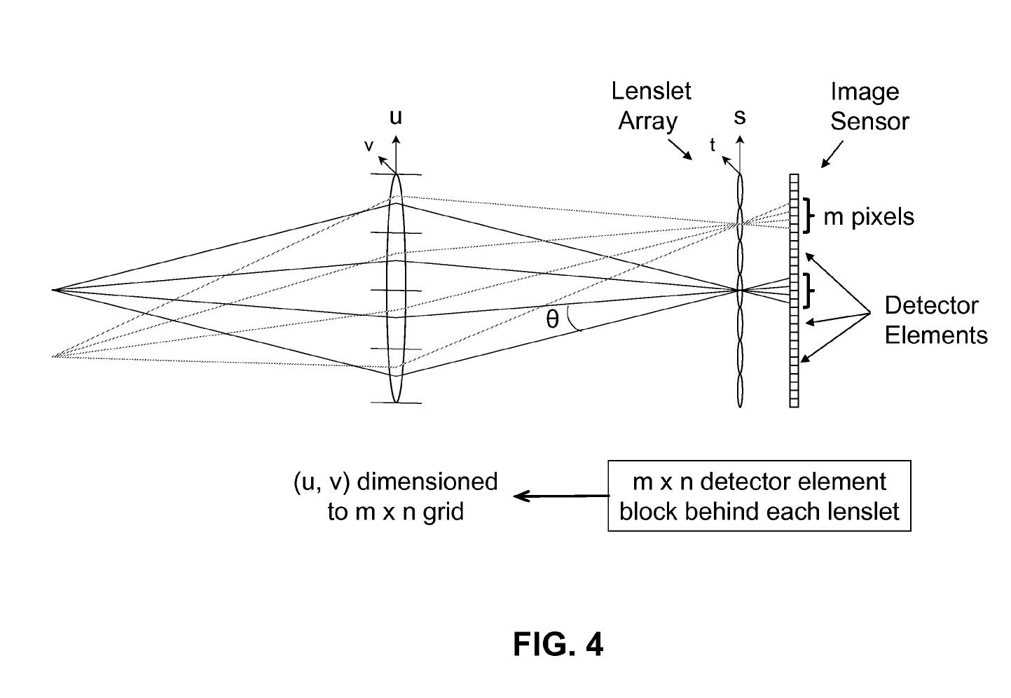

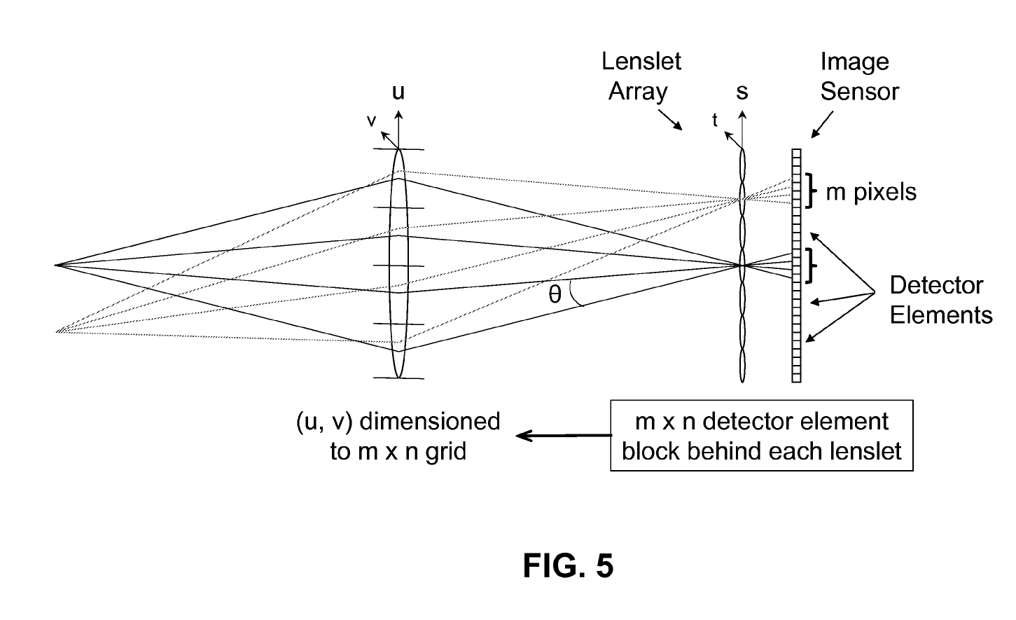

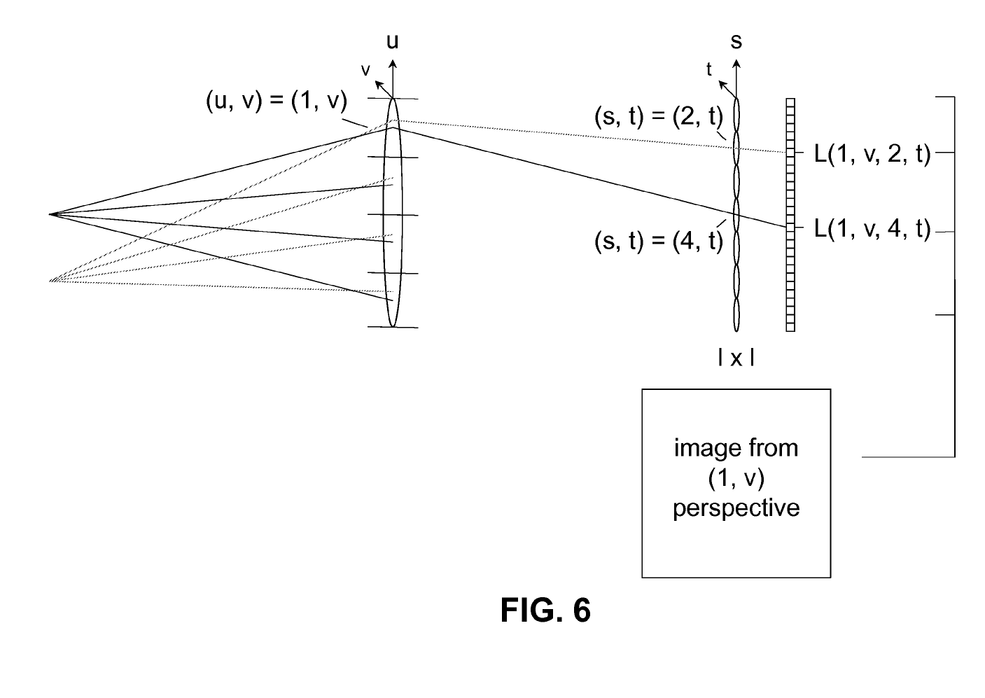

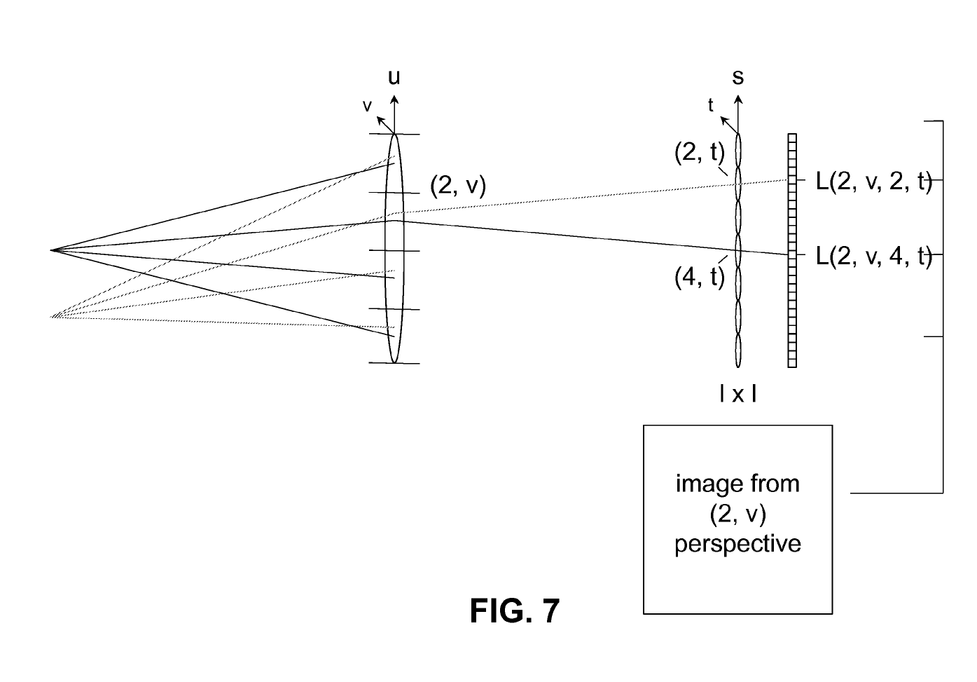

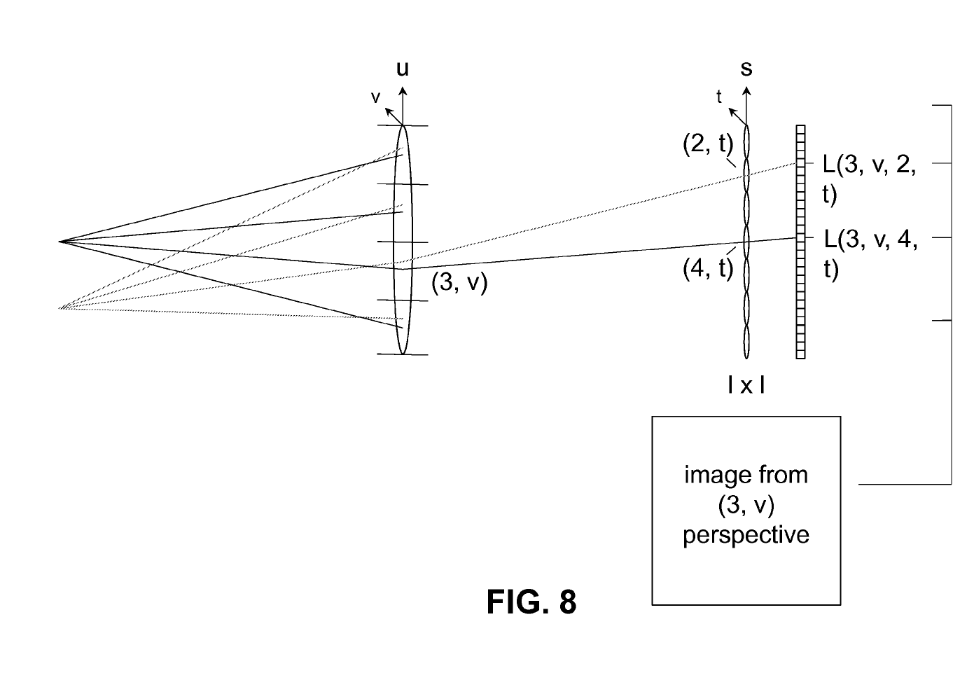

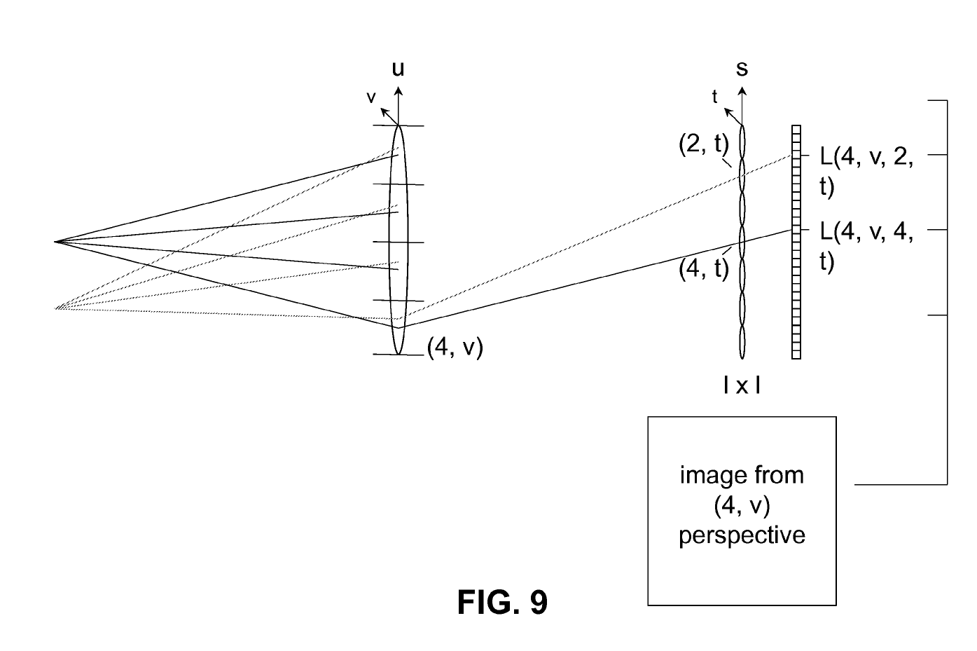

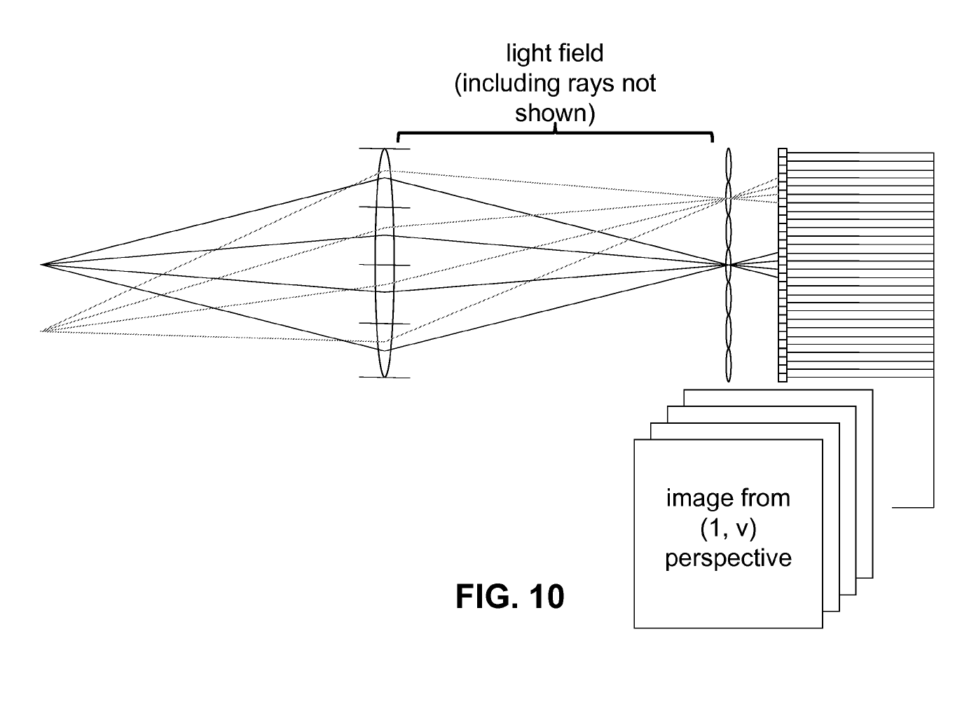

FIG. 4 is another example ray diagram illustrating that the lenslet array is placed at the usual detector array location. The dimension of the image is determined by the number lenslets. The image sensor comprises a two-dimensional (m×n) array of detector elements. FIG. 5 is another example ray diagram illustrating that the number of detector elements behind each lenslet determines the angular resolution of ray trajectories (the number of synthetic apertures in the imaging lens). FIG. 6 is another example ray diagram illustrating an image from a (1, v) perspective. FIG. 7 is another example ray diagram illustrating an image from a (2, v) perspective. FIG. 8 is another example ray diagram illustrating an image from a (3, v) perspective. FIG. 9 is another example ray diagram illustrating an image from a (4, v) perspective. As shown in FIG. 6, FIG. 7, FIG. 8, and FIG. 9, each detector element samples the intensity along a single ray L(u, v, s, t). And an area on the imaging lens may be treated as a “synthetic aperture,” wherein the associated pixels may be assembled to create an 1×1 image from that perspective. FIG. 10 is another example ray diagram illustrating the a complete set of L(u, v, s, t) constitutes the light field. The whole light field is captured one exposure.

Hyperspectral and multispectral imaging may be achieved via dynamic optical systems. Dynamic optical systems may comprise tunable filters in conjunction with imaging optics. Tunable filters used in spectral imaging may comprise filters whose spectral transmission can be controlled by applying a signal, thereto. Examples of tunable filters for spectral imaging may include liquid crystal filters. Liquid crystal based tunable filters may be electronically tunable. The spectral transmission of the filter may be tuned by applying an electric field to the liquid crystal cell.

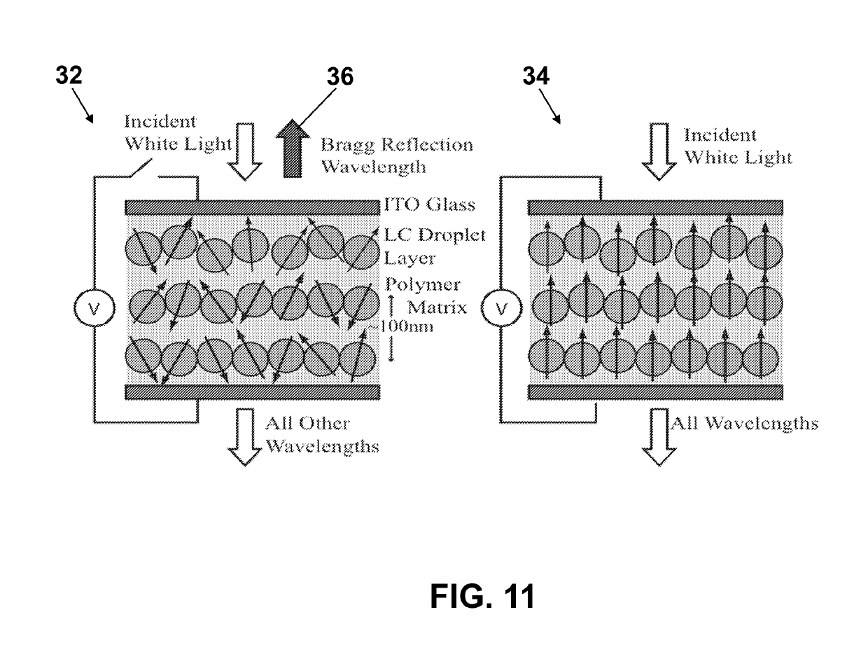

FIG. 11 is an example illustration of two states of an H-PDLC medium that may be achieved via electrical biasing. Illustration 32 depicts an H-PDLC medium having zero bias. That is, no external voltage is applied across the H-PDLC medium. Under zero bias conditions, a portion of the incident white light is reflected, indicated by arrow 36, from the top of the medium due to Bragg interaction between layers. Illustration 34 depicts an H-PDLC medium having an applied bias. That is, an external voltage is applied across the medium. With applied bias, the liquid crystal (LC) droplets align along a common axis to equalize the refractive indices of the LC and the polymer layer causing the Bragg reflected wavelength band to transmit.

The electrically controlled filters may comprise holographically formed polymer dispersed liquid crystal (H-PDLC) films. These films may be formed using an anisotropic cure of prepolymer using holographic techniques, allowing modulation of the LC droplet density on the order of the wavelength of the exposing light. Upon exposure to an interference pattern, polymerization may be initiated in the light fringes. The interference pattern may be formed, for example, by two coherent, counter-propagating laser beams. The rate of polymerization may be proportional to the square root of the light intensity for one-photon polymerization. Therefore, the rate of polymerization may be spatially dependent. A monomer diffusion gradient may be established as the monomer units are depleted in the bright fringes, causing migration of the monomers from the dark fringes. Polymer gelation may lock the modulated structure indefinitely. The result may be LC droplet-rich areas where the dark fringes were and essentially pure polymer regions where the light fringes were. They may be composed of periodic planes of liquid crystal rich and polymer rich regions.

A large refractive index modulation between the liquid crystal rich planes and the surrounding polymer planes may yield high diffraction/reflection efficiency and low residual scattering in the zero voltage state depicted in illustration 32 of FIG. 11. When the ordinary refractive index of the liquid crystal, nₒ, matches that of the polymer, nₚ, the H-PDLC reverts to a transparent state (with the material optically homogeneous) upon the application of a voltage, as depicted in illustration 34 of FIG. 11.

In an example embodiment, H-PDLC reflection-mode grating films may be directed to visible wavelength interactions such as, for example, flat panel displays, color filters, and optical sensors. In this example embodiment, gratings may be formed using visible wavelength laser radiation (e.g., 514 nm or 532 nm) and a corresponding materials set that absorbs radiation in the laser emitted regime. These materials may demonstrate reflection efficiencies of 85-90%, switching fields ˜15-20 V/μm, and switching times <2 ms. Preliminary results from wavefront measurement experiments using a Zygo white light interferometer reveal wavefront shifts less than 0.0052λ.

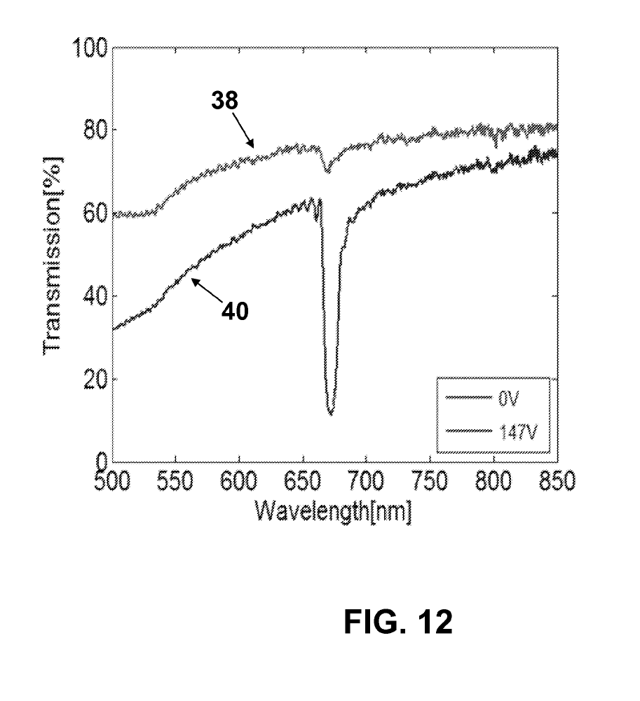

FIG. 12 depicts graphs of example transmission spectra of an H-PDLC filter with and without applied voltage. Graph 38 depicts a transmission spectrum of an H-PDLC filter having 147 volts applied thereto. Graph 40 depicts a transmission spectrum of the same H-PDLC filter have zero volts applied (unbiased) thereto. As can be seen from the graphs in FIG. 12, the transmission spectrum 40 of the unbiased H-PDLC filter has a notch in wavelength between approximately 650 nanometers to 750 nanometers. This notch represents the Bragg reflected wavelengths of the unbiased H-PDLC filter. And as can be seen in graph 38 of the biased H-PDLC filter, the notch is significantly reduced.

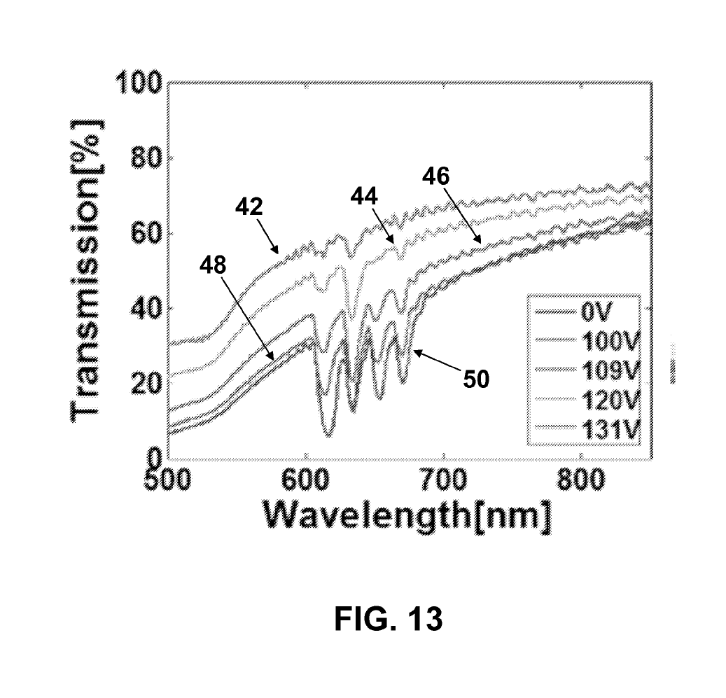

FIG. 13 depicts graphs of example transmission spectra of a five layer multicolor H-PDLC filter stack with varying applied voltage. H-PDLC technology may be utilizable in color filtration applications. Configured in a multi-color stack, H-PDLCs may be electrically tuned to reject any given visible wavelength through color addition algorithms). Many different color H-PDLCs may be stacked allowing finer control over the rejected wavelengths. This application may be particularly suited to CCD color filtration, especially for remote sensing and hyperspectral work where moving parts are to be avoided. Each of graphs 42, 44, 46, 48, and 50 represent a transmission spectrum of a different color H-PDLC filter. Graph 50 represents a transmission spectrum of an unbiased an H-PDLC filter of the stack configured to a first color. Graph 48 represents a transmission spectrum of an H-PDLC filter of the stack biased with 100 volts and configured to a second color. Graph 46 represents a transmission spectrum of an H-PDLC filter of the stack biased with 109 volts and configured to a third color. Graph 44 represents a transmission spectrum of an H-PDLC filter of the stack biased with 120 volts and configured to a fourth color. Graph 42 represents a transmission spectrum of an H-PDLC filter of the stack biased with 131 volts and configured to a fifth color. It is to be understood that an H-PDLC filter stack concurrently may comprise any appropriate number of filters, wherein each filter may be biased with any appropriate voltage, and wherein each filter may be configured for any appropriate color. An H-PDLC filter may reflect the same Bragg wavelength over the entire area of the substrate. Additionally, it is possible to form multiple filters within the same cell (a “spectral mask”) through spatial multiplexing techniques. To achieve the spatial multiplexing, the holographic process is changed such that different regions of the H-PDLC are exposed to different interference patterns. This procedure results in an array of reflection filters on a single substrate. By preparing the substrate properly, each filter may be controlled individually.

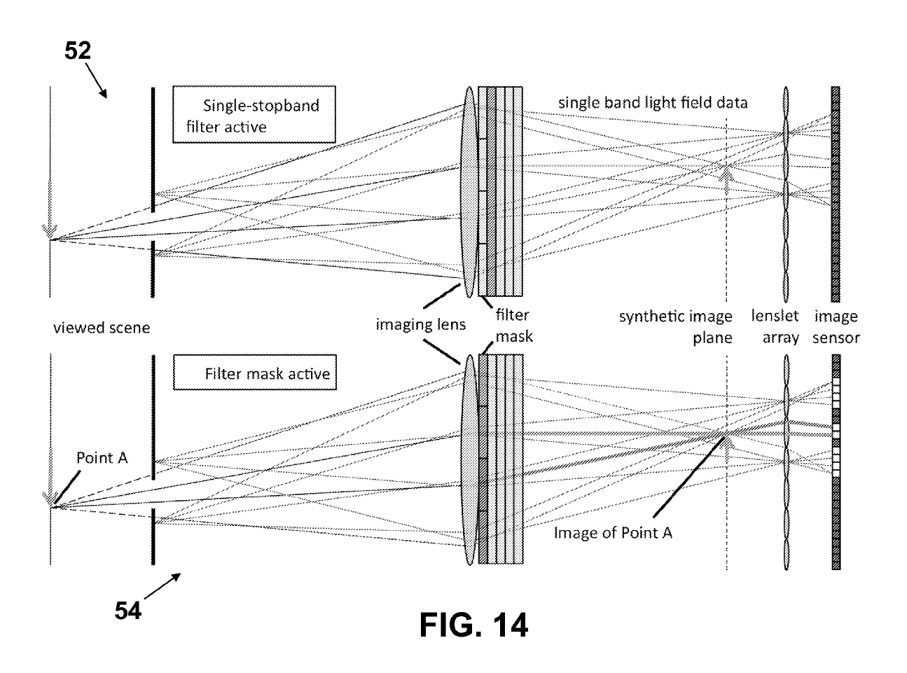

FIG. 14 depicts ray diagrams of the herein described dynamically focusable light field imaging system with a stack including single-stopband filters and a filter mask. As depicted in configuration 52, a single-band filter is active and the full light field for the given waveband is captured. By making different single-band filters active, a spectral light field L(λ, u, v, s, t) may be generated. As depicted in configuration 54, the filter mask is made active and passes the indicated colors. Rays are colored as if the filters were passband filters transmitting only a single waveband. The H-PDLC filters may reflect the shown waveband, and a grayscale exposure may serve as a baseline to determine the intensity at each wavelength.

The example plenoptic camera configuration depicted in FIG. 14 may comprise a stack of H-PDLC filters at the lens plane in order to capture spectral or pseudo-spectral light field data. As depicted in configure 52, the stack may comprise single-stopband filters, each of which may block a different waveband when no voltage is applied, and become transparent when a voltage is applied. In order to capture the spectral light field, all but one filter may be made transparent for each following exposure. Each of these exposures alone may facilitate calculation of the light filed for that particular waveband. By assembling the individual light fields for each band, the spectral light field L(λ, u, v, s, t) may be captured.

In an example H-PDLC filter geometry, a single H-PDLC filter mask may be used at the image plane to facilitate capture of snapshot spectral images (two exposures) or pseudo-spectral light field data (e.g., depicted in stack 28 of FIG. 1). This filter mask may be patterned with different stopbands across its plane, transverse to the optical axis. In an example embodiment, this may comprise a grid of squares, each with a different stopband. Other example geometries may concentric rings. The inclusion of this mask may create a system employing static filters, but with extended capabilities enabled by the use of switchable filters. Configuration 54 may, in two exposures, capture the information to reconstruct a simple spectral image at the lenslet plane and a grayscale light field. Spectral digital refocus may be accomplished with a combination of the spectral data and grayscale light field data. In an example embodiment, a single-exposure multispectral capture may be accomplished without the grayscale exposure, wherein a clear aperture may be included, in a variety of geometries, on the filter mask.

In another example embodiment, the herein described dynamically focusable light field imaging system may comprise a hybrid multispectral/light field camera that has the capabilities of the systems described herein for activation independently or in combination, as needed. For example, such a hybrid camera may comprise a filter mask that is gridded with four stopbands in a stack with four single-stopband filters, each with one of the stopbands in the mask as depicted in FIG. 14. A user could choose whether to capture a snapshot multispectral image, activating the filter mask, for a dynamic scene that does not allow for several exposures or a preliminary assessment as to whether the scene is worth capturing light field data from. With the same device, a user could then choose to capture the full spectral light field by activating the single-stopband filter portion of the stack.

Creation of a stack of filters suited for multispectral light field capture through incorporation into a plenoptic camera system as described herein may be accomplished with a single filter, capable of capturing the light field corresponding to its stopband in two exposures. One exposure may be with the filter reflective and a second exposure, to provide a baseline measurement, may be with the filter transparent. By stacking a set of filters of different stopbands along the optical axis of the camera and holding all but one transparent per exposure, a spectral light field with as many bands as filters may be captured.

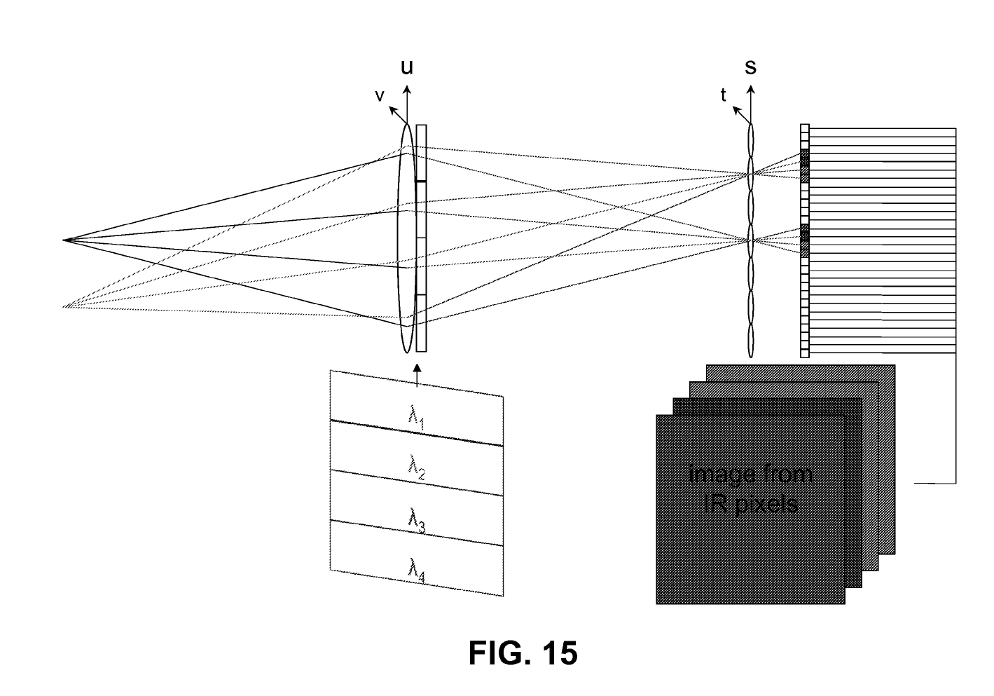

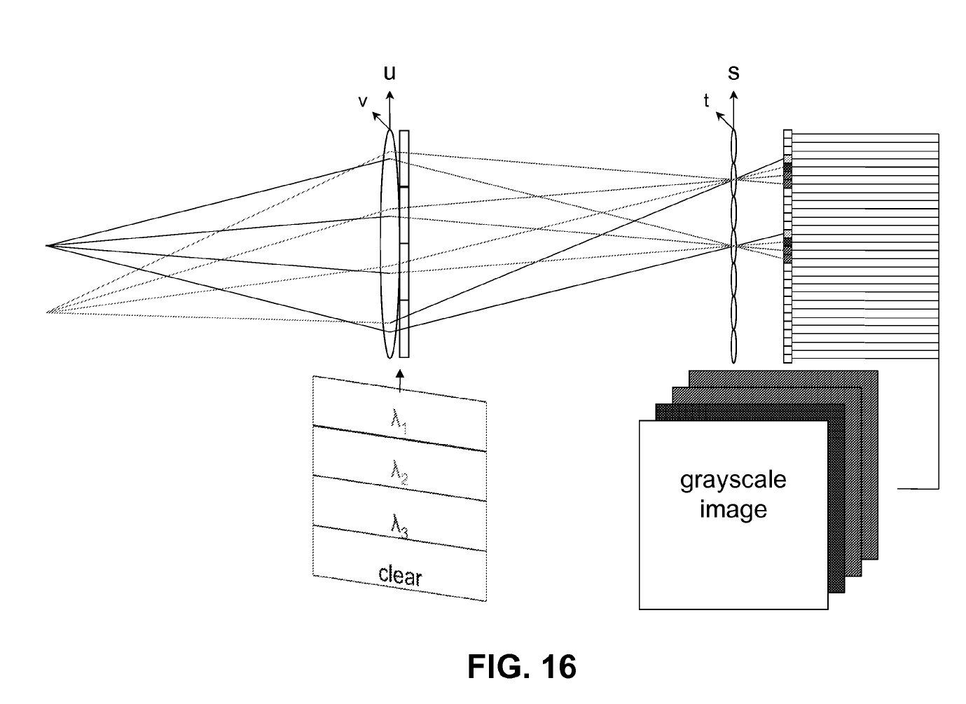

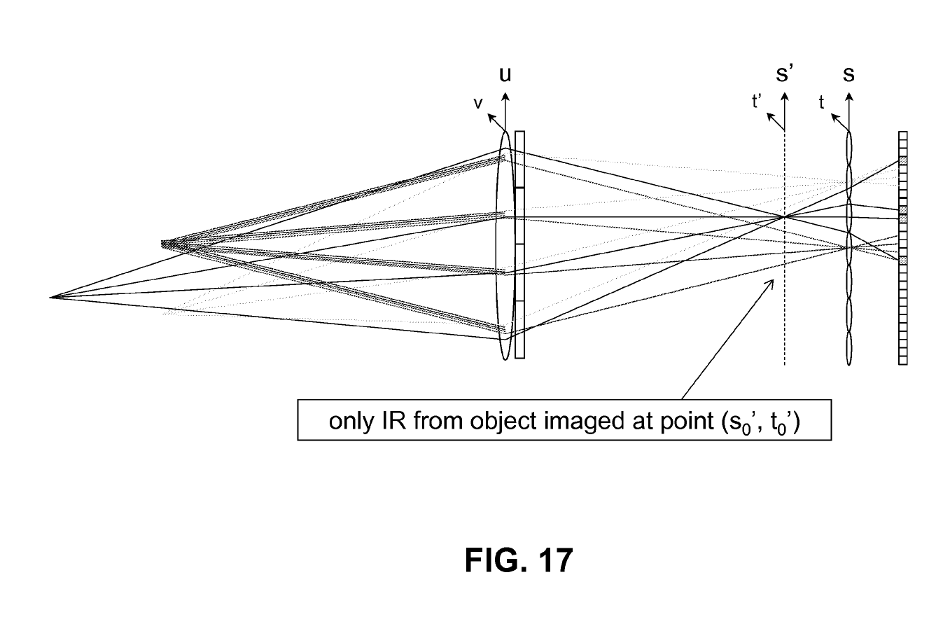

FIG. 15 is another example ray diagram illustrating introduction of a filter array proximate the imaging lens. The partitions of the filter array may filter different wavelengths, intensity, polarization, of any appropriate combination thereof. As shown in FIG. 15, the trajectory information is converted to spectral information. FIG. 16 is another example ray diagram illustrating the dynamic filters turned off. With the dynamic filters off, a reference may be included in the form of a clear aperture for comparison to other sub-images. FIG. 17 is another example ray diagram illustrating an array of static filters. As depicted in FIG. 17, with static filters, the ability to digitally refocus is lost because the wavelength (2) is not known for all trajectories (v, u)→(s, t). As shown in FIG. 17, (v, u) essentially is converted to λ resulting in L(s, t, λ). This is nearly the same as a conventional two-dimensional (2-D) slice of a four-dimensional (4-D) field. However, spectral information is lost at (s′, t′) for any out-of-focus rays.

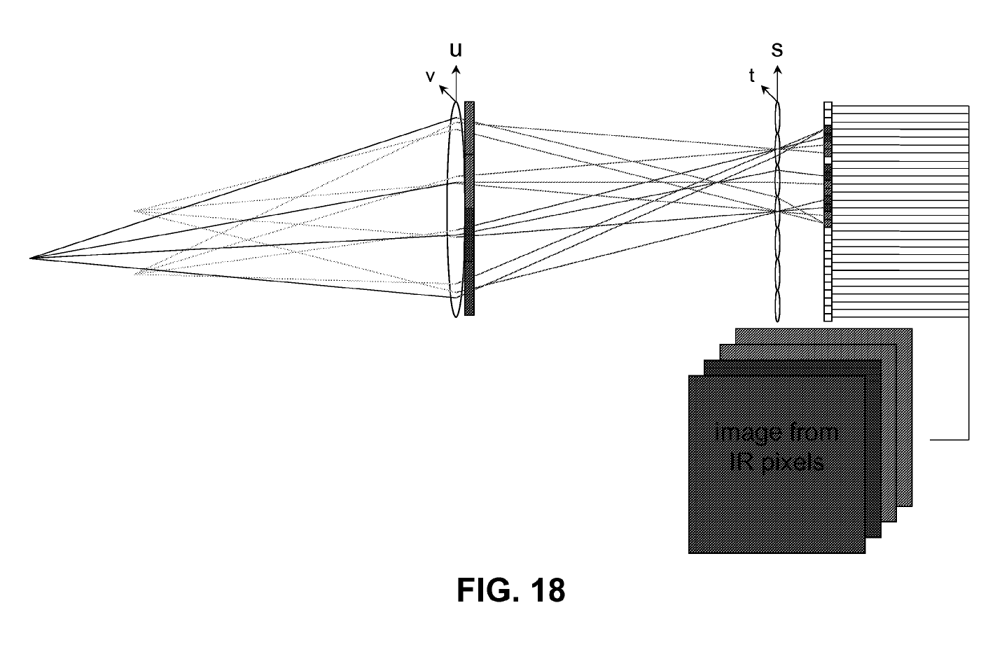

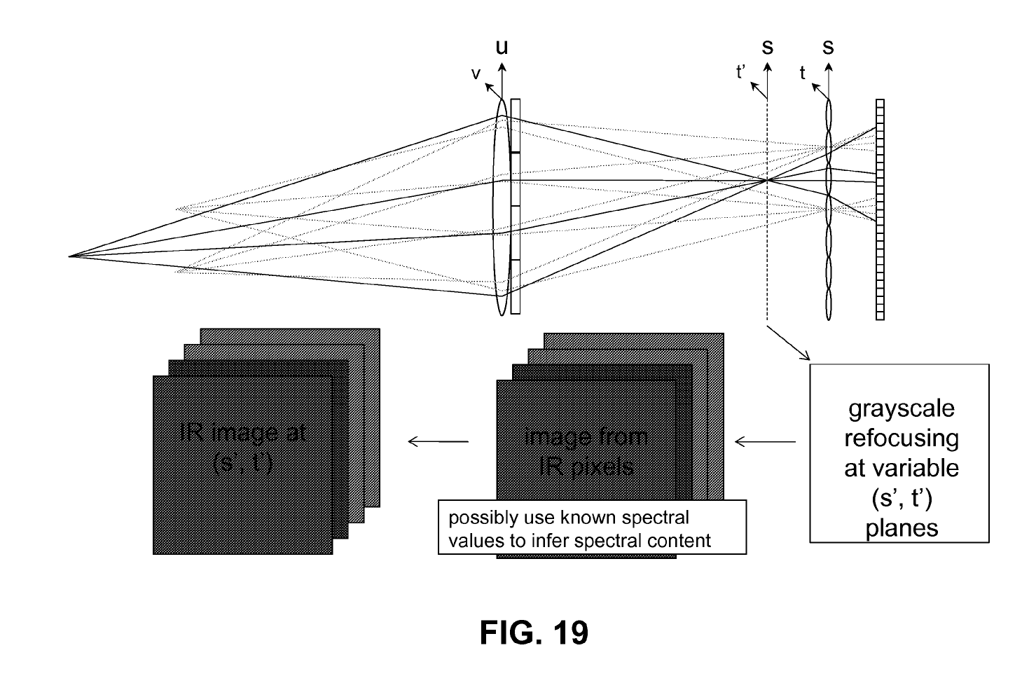

FIG. 18 is another example ray diagram illustrating a two-exposure technique wherein all filters are on and are subsequently turned off And FIG. 19 is another example ray diagram illustrating a two-exposure technique wherein all filters are off and are subsequently turned on. These techniques exploit the switching capabilities of the dynamic filters. The entire array may be switched at once. This may result in a grayscale light field L(u, v, s, t) and 2-D L(s, t, λ) at the lenslet plane. When the filters are off, the reference values are given as well as light filed information.

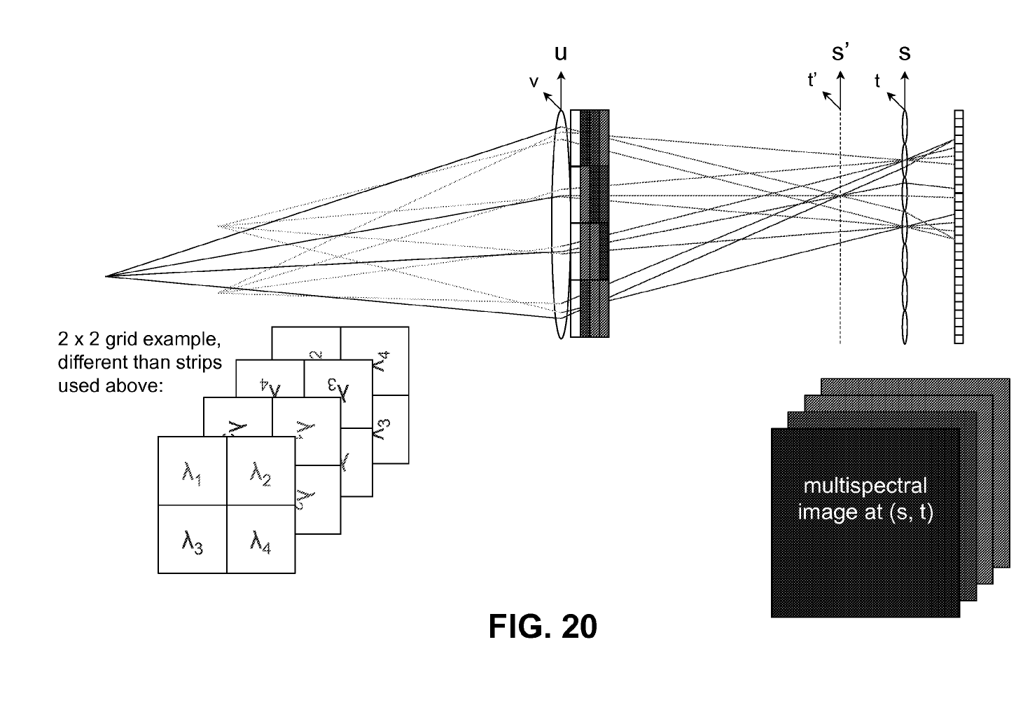

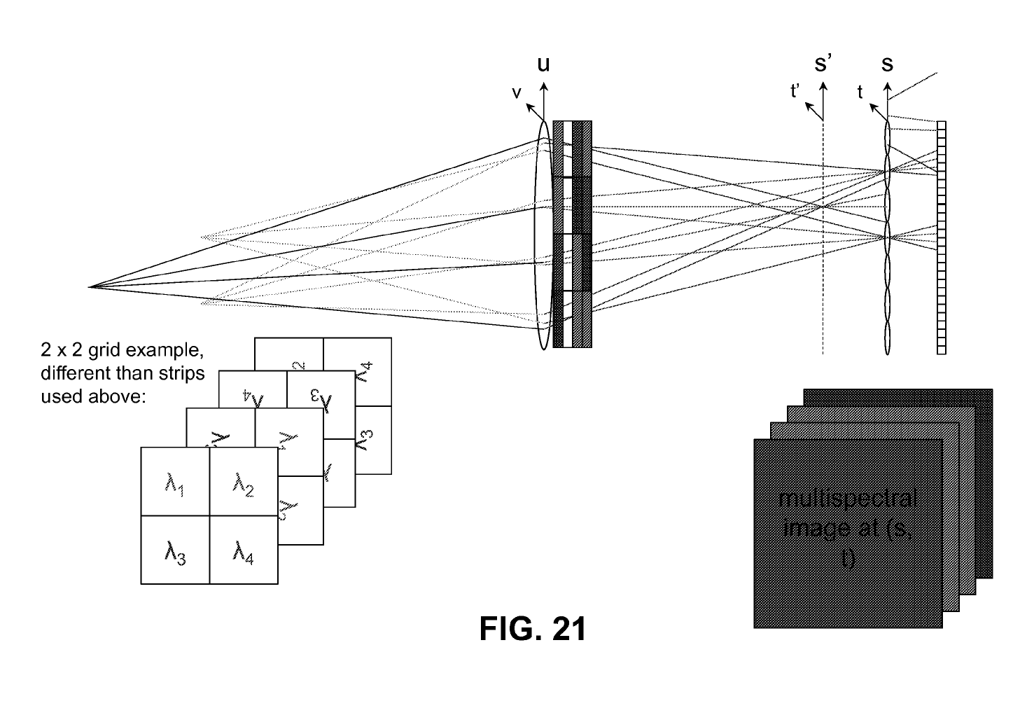

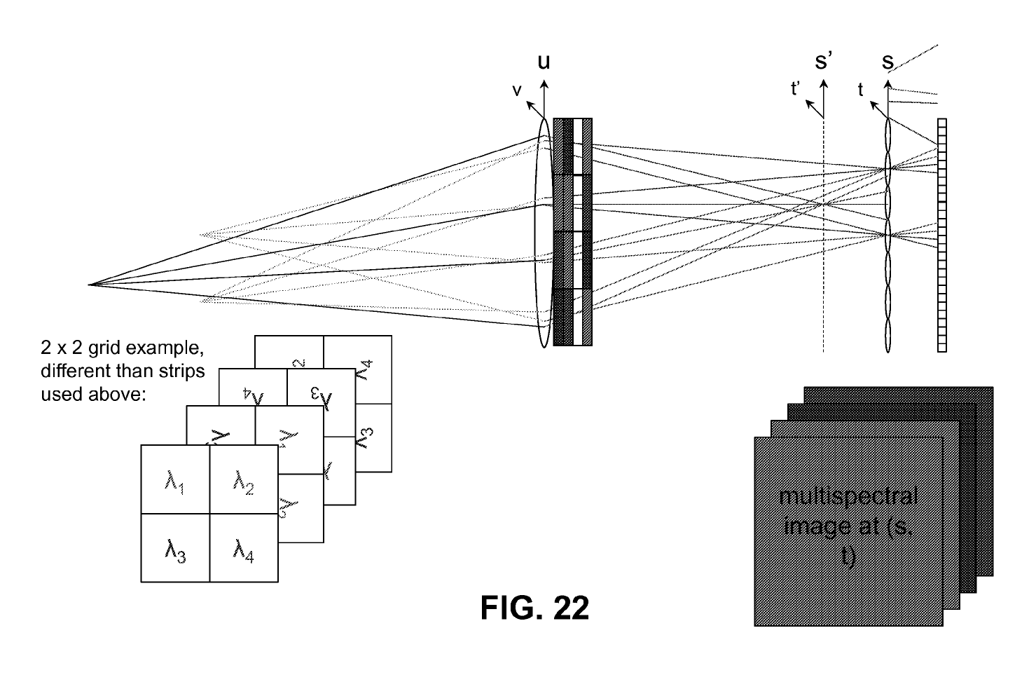

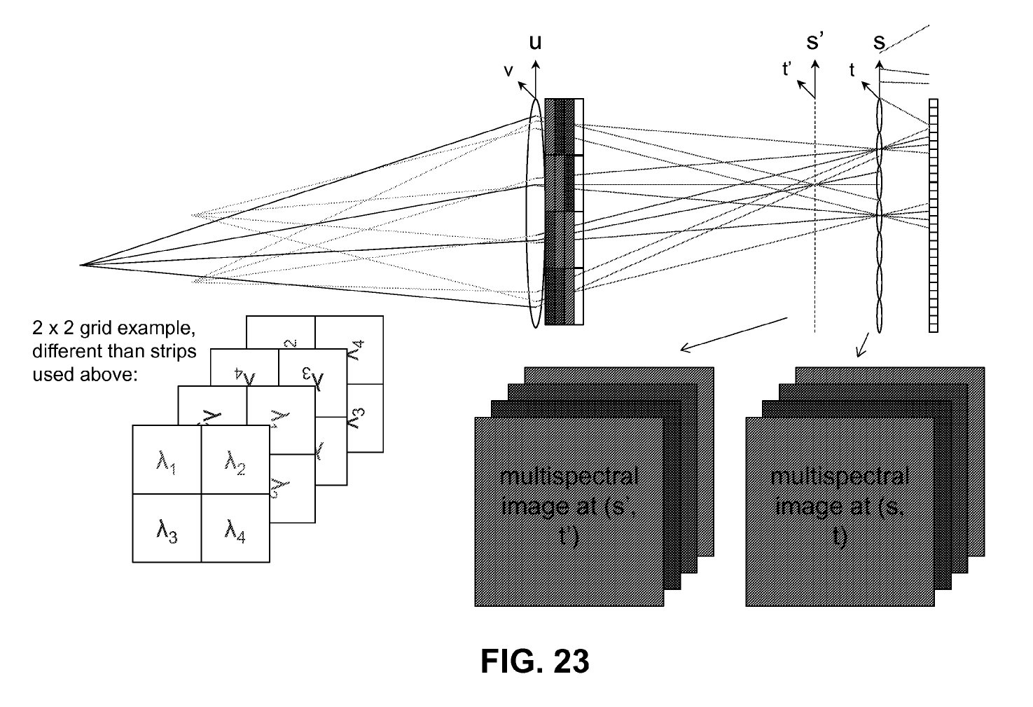

FIG. 20, FIG. 21, FIG. 22, and FIG. 23 are another example ray diagram illustrating stacked filters wherein different filters of the stacks are activated. One exposure may be obtained per filter element. Each array may be identical and rotated 90 degrees with respect to its neighbor (e.g., 2×2 grid). The stacked filter configuration allows for complete capture of multispectral light field L(u, v, s, t, λ). The entire array is addressed and no references may be needed.

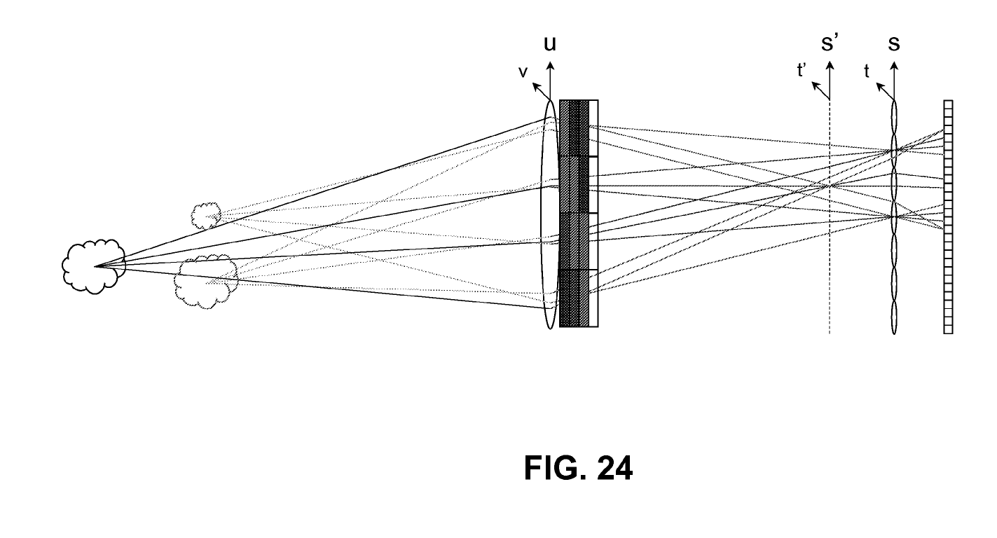

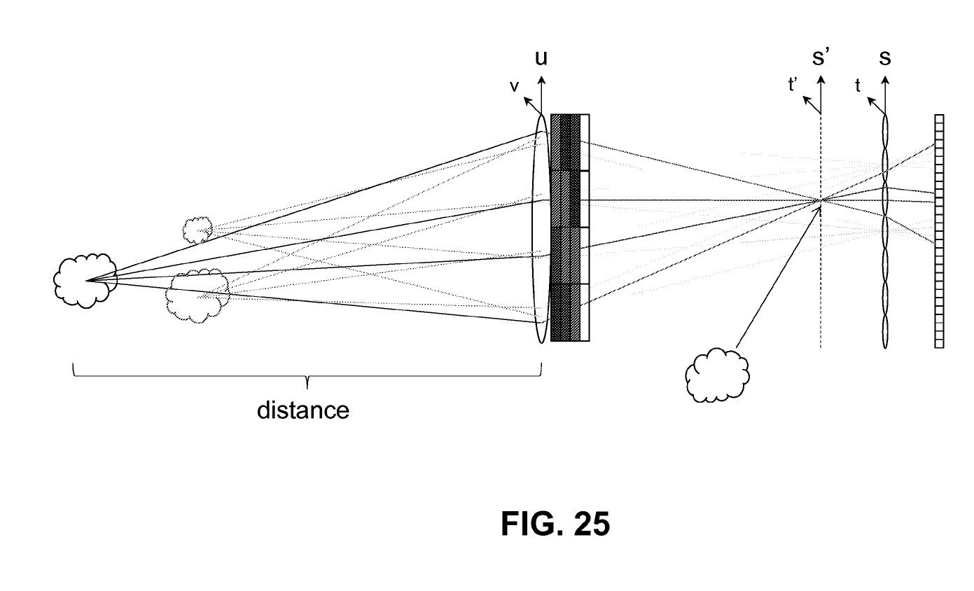

FIG. 24 is another example ray diagram illustrating target chemical detection. FIG. 25 is another example ray diagram illustrating target chemical detection wherein specific filters are chosen based upon the specific task. The configurations depicted in FIG. 24 and FIG. 25 may be utilized to detect, identify, localize, and/or range a target chemical or the like. For example, a five-dimensional multispectral light field, L(u, v, s, t, 4 may be searched for 2-D Fourier slices, L(s′, t′), with the highest intensity of spectral signal due to focus vs. de-focus. In an example embodiment, a fast camera capturing four exposures to assemble the light field may be used.

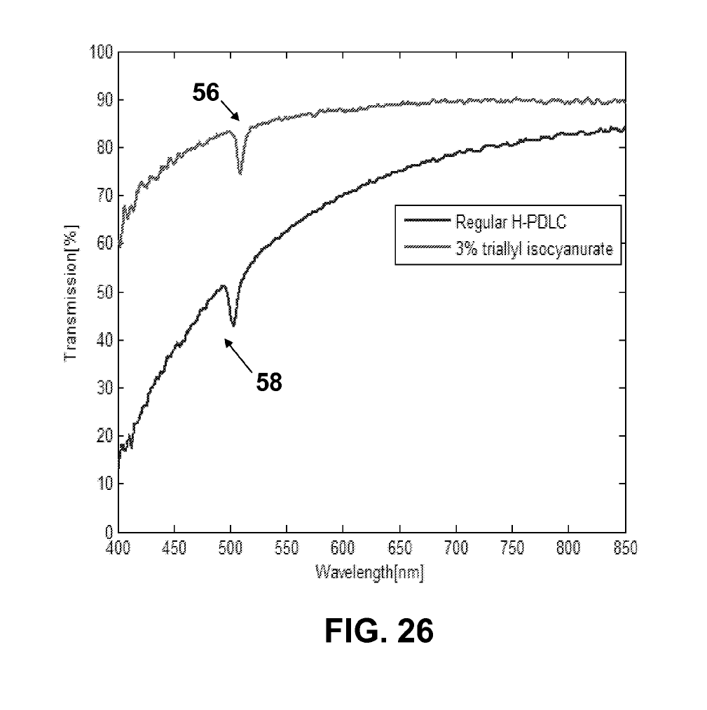

Various materials, configurations, and formulations may be utilized to generate the herein described dynamically focusable light field imaging system. For example, off band scattering may be reduced with the addition of triallyl isocyanurate into the H-PDLC recipe. FIG. 26 illustrates example graphs of transmission spectra for an H-PDLC medium comprising triallyl isocyanurate and an H-PDLC medium not comprising triallyl isocyanurate. Graph 56 represents the transmission spectrum of an H-PDLC medium comprising 3% triallyl isocyanurate. Graph 58 represents the transmission spectrum of an H-PDLC medium comprising no triallyl isocyanurate. As can be seen in FIG. 26, the addition of triallyl isocyanurate decreases the off-band scattering significantly across the visible spectrum. The addition of the triallyl isocyanurate also may speed up the reaction kinetics, leading to smaller liquid crystal droplet sizes. The reduction of droplet size may lead to a reduction in scattering in the visible spectrum. In addition, reaction kinetics may be changed by varying the polymer used and by varying the temperature at which the H-PDLC is cured. Studies will be performed to determine the optimal polymer composition and curing temperature with regards to a reduction in scattering. The number of glass-polymer interfaces may be reduced by replacing glass substrates between individual filters with spin coated conductive and insulating polymer. This may reduce index-mismatched interfaces and may increase transmission through the filter stack.

An example plenoptic camera comprising an H-PDLC filter stack for spectral light field capture may comprise any appropriate components in any appropriate arrangement, such as, for example, a front imaging lens system, a lenslet array, an image sensor, hardware/software for coordination of filter cycling, camera triggering, and data storage, or any appropriate combination thereof.

In an example embodiment, H-PDLC filter stacks may be incorporated into a commercial digital camera body/lens system. In another example embodiment, a tailored optical system may be designed and configured that incorporates an image sensor chip or the like. In an example embodiment, an imaging lens with low f-number and low aberration over a large range of focus, without actually incorporating an adjustable focus may be utilized. This will allow the camera to collect a large amount of light and produce high-quality reconstructed images.

In an example embodiment, a lenslet array with a low f-number, matching the imaging lens, and a large number of lenslets may be utilized. To create a compact, high-resolution system, a lenslet array with lenses of small diameter and a corresponding focal length may be utilized. In an example embodiment a custom lenslet array may be fabricated. Because the number of lenslets in the array may limit the pixel resolution of reconstruction images, a relatively large array may be utilized. While small lenslets may appear opportune, reducing the diameter of the lenslets may increase the magnitude of diffraction effects. We may be able to model these effects and attempt to remove them through light field modeling, but we cannot assume this.

In an example embodiment, an image sensor may comprise a full-frame (˜35 mm), multimodal image sensor. Fabrication and fundamental limits (diffraction) on lenslet size may imply that each lenslet has a substantial diameter. To contain enough lenslets to achieve modest pixel resolutions, the lenslet array size may become comparable to that of full-frame detector arrays. Large area detector arrays are, by nature, limited in speed. In order to capture live video, alternate solutions (e.g., smaller arrays operating together) and custom detector array designs may be utilized.

In an example embodiment, the plenoptic camera assembly and control may include a mounting system that allows removal and replacement of filter stacks and facilitates electrical connections for switching while remaining sufficiently close to the plane of the imaging lens (or appropriately placed within a compound lens system). In an example embodiment, the lenslet array may be aligned close to the image sensor (e.g., ˜0.5 mm).

An experimental plenoptic camera was designed and constructed. The set of lenslet arrays utilized were originally intended for wavefront sensors, and the lowest f-number available was 52.63 (10 mm focal length with 190 mm pitch). Matching the f-number of the lenslet array to the object-side focal length of the imaging lens may maximize use of the detector array without having the light from adjacent lenslets multiplexed at the image sensor plane. To match the f-number of the lenslets, a simple lens with a 50 cm focal length and 2.56 cm diameter, was chosen. Further the lens was stopped down to half its aperture (˜1.28 cm) with an iris and placing the lenslet array, approximately, 66.8 cm from the imaging lens. A grayscale camera was chosen. The camera chosen was a Basler A600f with 658×491 image sensor pixels of 9.9 mm pitch. The implication being that a region of 25×25 pixels behind each lenslet is the number of locations into which the u-v plane may be partitioned. and, by the theory in Section 2.1, that is the number of locations we may partition. The distance between the lenslets and camera image sensor was determined by imaging a white scene, with a pinhole iris near the imaging lens, and translating the lenslet array until the spot size produced on the image sensor was minimized, implying that it was one focal length from the lenslet array (˜1 cm). To prevent light from adjacent lenslets from falling onto the same detectors, the aperture of the iris at the lens plane was reduce to produce a useful region of 17×17 pixels behind each lenslet.

For image reconstruction, each u-v area was treated at the main lens as a pinhole camera that produces an image at the desired refocus plane and integrates the contribution of all u-v coordinates to each s′-t′ pixel. 25×32 full lenslets sat over the detector array, so this was the pixel resolution used in image reconstruction.

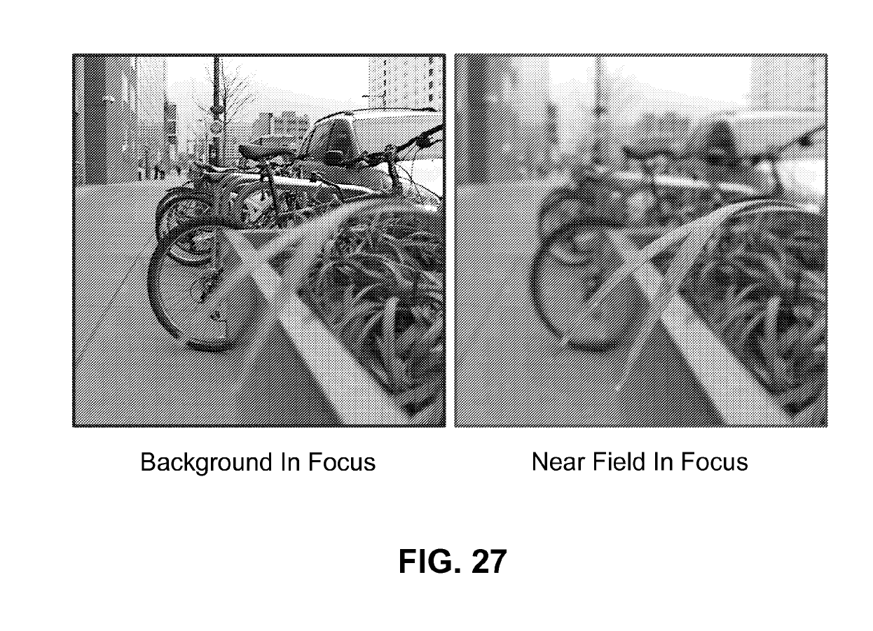

FIG. 27 illustrates digitally-refocused images created from the light field data captured in a single exposure from the trial system. As can been seen in FIG. 27, the background is in focus in the left panel and the near field (foreground) is in focus in the right panel.

In order to manipulate and visualize spectral light field data, the spectral light field data may be stored. Light field data as captured by the herein described dynamically focusable light field imaging system may be a five-dimensional light field L(λ, u, v, s, t). In multispectral imaging, the data captured is a hypercube with a spectrum for each two-dimensional coordinate. As an analog to digitally refocusing images with a standard plenoptic camera, digitally-refocused, spectral hypercubes of the scene may be created.

In order to digitally refocus in a single waveband, a hierarchy may be assigned to the spectral light field data wherein an individual waveband (or combination of wavebands to create a unique color space) may be selected and digitally-refocused images with the information from that single band may be created.

In order to digitally refocus the spectral hypercube, a hierarchy may be assigned to the spectral light field data wherein digitally-refocused, spectral hypercubes for a desired focal depth may be created. By choosing a specific pixel in the spatial dimensions, the spectrum at that point may be viewed. Further, areas of specific spectral content within a grayscale image generated from the refocused hypercube may be highlighted.

Angularly-resolved spectral distribution may be determined from scene points. Given a refocused hypercube, the angular content of all ray bundles contributing to a spatial pixel in the reconstructed image may be extracted. By isolating these rays and treating them individually, the character of each ray originating from a scene point through its correspondence to the image point may be analyzed.

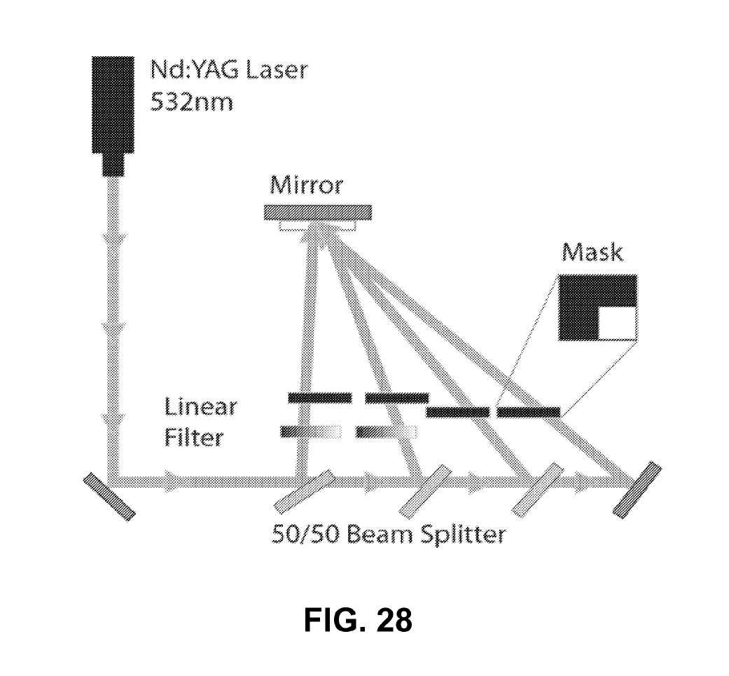

FIG. 28 illustrates an example configuration for forming four spatially multiplexed H-PDLC filters on a single substrate. The four different beams create four different interference patterns on the substrate. Masks may be used to control which region of the substrate is exposed by each beam. Accordingly, novel H-PDLC filter stacks may be created that comprise single-stopband filters and filter arrays to create a highly flexible imaging system. Where a single-stopband filter allows for information only at one waveband to be captured per exposure, filter masks may provide information about any appropriate number of stopbands. Combinations of filter masks may allow for rapid throughput, in terms of wavebands sampled. Fabrication techniques may include spin-coating of film layers, use of conducting polymer conducting layers, re-optimizing triallyl isocyanurate concentrations for stack integrated layers, or any appropriate combination thereof.

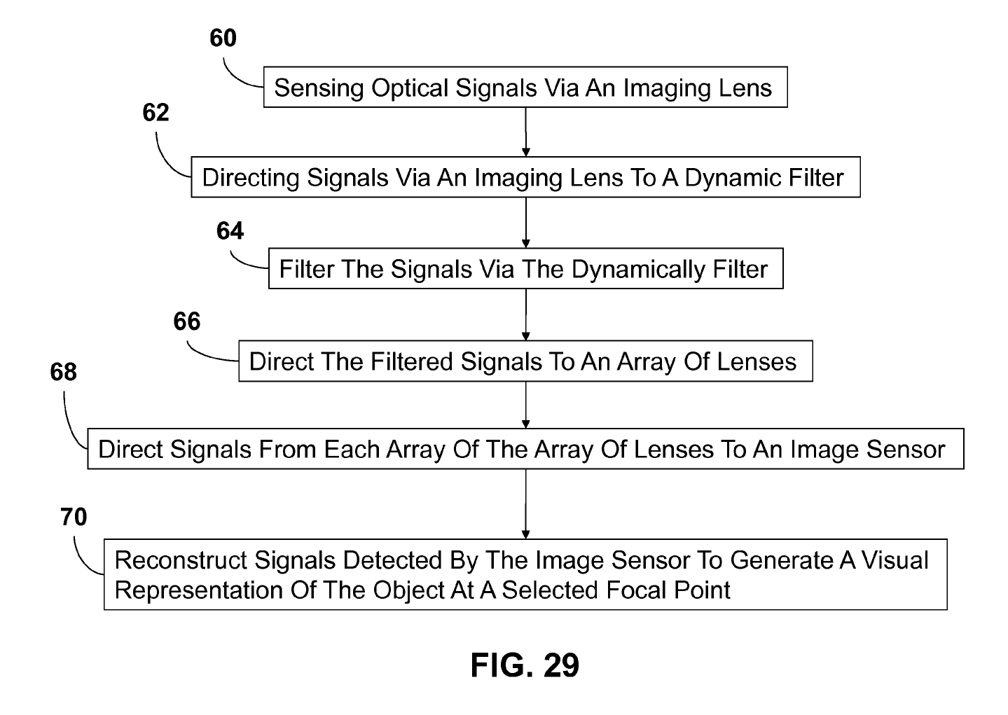

FIG. 29 is a flow chart of an example process for dynamically focusable light field imaging as described herein. At step 60, optical signals may be sensed by an imaging lens (e.g., imaging lens 24 of FIG. 1). The optical signal may comprise any appropriate signal as described herein (e.g., visible light, nonvisible light, infrared light, etc.). The optical signal may represent any appropriate object, objects, plane(s) of objects, or the like. At step 62, the signals received by the imaging lens may be directed to a dynamic filter (e.g., H-PDLC filter, H-PDLC filter stack 20 of FIG. 1). At step 64, signals received by the dynamical filter may be filtered as described herein. At step 66, the filtered signals may be directed to an array of lenses (e.g., lenslet array 16 of FIG. 1). At step 68, signals passing through each lens of the array of lenses may be direct to an image sensor (e.g., image sensor 18 of FIG. 1). At step 70, the signals received by detectors of the array of detectors may be reconstructed to generate a visual representation of the object or objects, wherein reconstruction may include dynamically focusing the visual representation at any appropriate selectable focal point or plane, as described herein.

While example embodiments of dynamically focusable light field imaging have been described in connection with various computing devices/processors, the underlying concepts may be applied to any computing device, processor, or system capable of implementing dynamically focusable light field imaging. The various techniques, processes, and/or methods described herein may be implemented in connection with hardware, or hardware and software. Thus, the techniques, processes, methods, and/or apparatuses for dynamically focusable light field imaging may be implemented, or certain aspects or portions thereof, may take the form of program code (i.e., instructions) embodied in tangible storage media having a concrete, tangible, physical structure. Examples of tangible storage media include floppy diskettes, CD-ROMs, DVDs, hard drives, or any other tangible machine-readable storage medium having a tangible, concrete, physical structure (tangible computer-readable storage medium). Thus, a tangible storage medium as described herein is an article of manufacture. A tangible storage medium as described herein is not to be construed as a propagating signal. A tangible storage medium as described herein is not to be construed as a transient signal. When the program code is loaded into and executed by a machine, such as a computer, the machine becomes an apparatus for implementing and/or facilitating dynamically focusable light field imaging as described herein. In the case of program code executing on programmable computers, the computing device may generally include a processor, a storage medium readable by the processor (including volatile and non-volatile memory and/or storage elements), at least one input device, and at least one output device. The program(s) may be implemented in assembly or machine language, if desired. The language can be a compiled or interpreted language, and combined with hardware implementations.

While dynamically focusable light field imaging has been described in connection with the various embodiments of the various figures, it is to be understood that other similar embodiments may be used or modifications and additions may be made to the described embodiments for dynamically focusable light field imaging without deviating therefrom. Therefore, although dynamically focusable light field imaging has been described herein with reference to preferred embodiments and/or preferred methods, it should be understood that the words which have been used herein are words of description and illustration, rather than words of limitation, and that the scope of the instant disclosure is not intended to be limited to those particulars, but rather is meant to extend to all structures, methods, and/or uses of the herein described tunable electro-optic filter stack. Those skilled in the relevant art, having the benefit of the teachings of this specification, may effect numerous modifications to dynamically focusable light field imaging as described herein, and changes may be made without departing from the scope and spirit of the instant disclosure, for instance as recited in the appended claims.

What is claimed is:

1. A method comprising:
directing optical signals, via an imaging lens, to a dynamic filter, wherein the optical signals are representative of an object;
filtering, by dynamic filter, the directed signals;
directing filtered signals to an array of lenses;
directing signals from each lens of the array of lenses to an image sensor, wherein the image sensor comprises a plurality of detector elements; and
reconstructing signals detected by detector elements of the plurality of detector elements to generate a visual representation of the object, wherein reconstructing the signals comprises dynamically focusing the visual representation at a selectable focal point.

2. The method of claim 1, wherein the dynamic filter comprises a holographically formed polymer dispersed liquid crystal spectral filter.

3. The method of claim 1, wherein the dynamic filter comprises a stack of holographically formed polymer dispersed liquid crystal spectral filters.

4. The method of claim 1, wherein an angular resolution of a ray trajectory of signals directed to the image sensor is based on a number of detectors elements of the plurality of detector elements.

5. The method of claim 1, wherein a number of synthetic apertures in the imaging lens is based on a number of detector elements of the plurality of detector elements.

6. The method of claim 1, wherein:
the dynamic filter comprises a plurality of holographically formed polymer dispersed liquid crystal spectral filters; and
filtering comprises concurrently configuring each filter of the plurality of holographically formed polymer dispersed liquid crystal spectral filters in a reflective state.

7. The method of claim 6, wherein each filter of the plurality of holographically formed polymer dispersed liquid crystal spectral filters reflects a respective and different wavelength.

8. The method of claim 1, wherein:
the dynamic filter comprises a plurality of holographically formed polymer dispersed liquid crystal spectral filters; and
filtering comprises concurrently configuring all filters of the plurality of the holographically formed polymer dispersed liquid crystal spectral filters in a reflective state and subsequently configuring all filters of the plurality of the holographically formed polymer dispersed liquid crystal spectral filters in a transparent state.

9. The method of claim 1, wherein:
the dynamic filter comprises a plurality of holographically formed polymer dispersed liquid crystal spectral filters; and
filtering comprises concurrently configuring all filters of the plurality of the holographically formed polymer dispersed liquid crystal spectral filters in a transparent state and subsequently configuring all filters of the plurality of the holographically formed polymer dispersed liquid crystal spectral filters in a reflective state.

10. The method of claim 1, wherein filtering comprises electrically controlling the dynamic filter.

11. A system comprising:
an imaging lens;
a dynamic filter positioned proximate the imaging lens;
an array of lenses; and
an image sensor comprising a plurality of detector elements, wherein:
signals received by detector elements of the plurality of detector elements are reconstructable to generate a visual representation of an object represented by optical signals received by the imaging lens; and
a focal point of the visual representation is selectable during reconstruction.

12. The system of claim 11, wherein the dynamic filter filters signals received from the imaging lens.

13. The system of claim 12, wherein:
the array of lenses receives signals from the dynamic filter; and
signals received by the array of lenses, upon passing through the array of lenses, is directed to the image sensor.

14. The system of claim 11, wherein the dynamic filter comprises a holographically formed polymer dispersed liquid crystal spectral filter.

15. The system of claim 11, wherein the dynamic filter comprises a stack of holographically formed polymer dispersed liquid crystal spectral filters.

16. The system of claim 11, wherein an angular resolution of a ray trajectory of signals directed to the image sensor is based on a number of detectors elements of the plurality of detector elements.

17. The system of claim 11, wherein a number of synthetic apertures in the imaging lens is based on a number of detector elements of the plurality of detector elements.

18. The system of claim 11, wherein:
the dynamic filter comprises a plurality of holographically formed polymer dispersed liquid crystal spectral filters; and
the dynamic filter processes signals received from the imaging lens by concurrently configuring each filter of the plurality of holographically formed polymer dispersed liquid crystal spectral filters in a reflective state.

19. The system of claim 18, wherein each filter of the plurality of holographically formed polymer dispersed liquid crystal spectral filters reflects a respective and different wavelength.

20. The system of claim 11, wherein the dynamic filter is controlled by providing an electrical bias to the dynamic filter.
